(19) United States
(12) Patent Application Publication
(10) Pub. No.: US 2016/0078490 A1
(43) Pub. Date: Mar. 17, 2016

(54) Systems and Methods for Monetizing Online Advertising by Users

(71) Applicants: Steve Tumen, Glencoe, IL (US); Kyle Tuskey, New York, NY (US)

(72) Inventors: Steve Tumen, Glencoe, IL (US); Kyle Tuskey, New York, NY (US)

(21) Appl. No.: 14/855,108

(22) Filed: Sep. 15, 2015

Related U.S. Application Data
(60) Provisional application No. 62/050,316, filed on Sep. 15, 2014.

(51) Int. Cl. G06Q 30/02

(52) U.S. Cl. CPC G06Q 30/0269

(57) ABSTRACT

A user-controlled advertising system including a user data storage including a user profile associated with the user device; a controller in communication with a network interface and a user data storage; memory instructions that cause the controller to: receive a request from the user device identifying content from a content provider; retrieve the content from the content provider; identify first advertising in the content; send an advertising request to the one or more advertiser systems, the advertising request identifying demographic information from the user profile; receive, from the one or more advertiser systems, a set of prospective advertisements, wherein each prospective advertisement is associated with a rate; select an advertisement from the set of prospective advertisements associated with a highest rate; when the selected advertisement exceeds a reserve rate defined by the user profile; replace the first advertising with the selected advertising; and provide the content to the user device.

### CROSS-REFERENCE TO RELATED APPLICATIONS

This application incorporates by reference and claims the benefit of priority to U.S. Provisional Patent Application No. 62/050,316 filed Sep. 15, 2014.

### BACKGROUND OF THE INVENTION

The present subject matter relates generally to systems and methods for monetizing online advertising and data by users. More specifically, the present invention relates to a consumer-controlled advertising and data system that provides advertisers with superior consumer targeting and conversion while permitting a consumer to control his or her personal information and receive compensation for viewing advertising.

Website publishers generate revenue by selling advertising content that is delivered to a user device along with the publisher's website content. Whether on desktop or mobile devices, content delivered via a browser or application may be accompanied by multiple forms of advertising including banner ads, video ads, interactive ads, in-app ads, and search result ads. This ad content is often tailored to a profile of the user that is generated by the collection of data with respect to a user's online history, habits, transactions and other information that can be linked to a particular device or user. This data may be collected by content publishers, app developers and machine-enabled tracking services via the use of “cookies” or other means. This tracking is facilitated, knowingly or unknowingly, by the settings that a user maintains on his/her device or within software and/or applications that run on the device (or are remotely connected to by the device). This information has grown to be incredibly valuable to many industries, including but not limited to the web publishing industry, the advertising industry, the software/app development industry and nearly any company that manufactures, distributes and/or sells consumer goods. Advertisers pay dearly for the right to send an ad to a user device with the hope of realizing an impression, click-thru, branding event or some other follow through action on the part of their audience. Internet advertising alone is currently estimated to be a $120B industry, estimated to grow to $160B in 2016. Roughly half of that number is generated by display ads.

Consider, as an analogy, the similarities between a browser and a billboard. While a browser is clearly more advanced, there are elements of a browser that are not a lot different than a billboard. For example, the intent of most billboard ads is to: (a) prompt a follow through action (similar to a click-thru in online advertising); and/or (b) create brand awareness (similar to an impression in online advertising). The billboard itself has a value, which can be measured by the amount of traffic by which it is viewed and the demographics of that traffic. The revenue generated by the billboard is typically shared by a number of parties, not the least of which is landlord of the property on which it sits.

Accepting the notion that a browser sits on a user's device, it follows that the user should share in the economic benefits generated by the activity on his/her devices. By analogy, the device is the property, the browser is the billboard on the property, and the device owner is the owner of the billboard and the property—and should be paid when advertisements are displayed on the device through the browser. This argument can be made for other user devices and or applications that host advertisements as well. Accordingly, there is a need for systems that permit users to share in the value created by their user devices.

Additionally, previous systems for delivering advertising content to a user device, whether the device is a desktop computer, a mobile device, a television, or a radio are limited to those historical observations of the user they are capable of observing, and not a user's current input. For example, for a user's web activity, observations are made on a website-by-website basis, they may not capture the user's full activity. Additionally, previous systems are limited by the fact that each user device manages its own connection directly to a disparate number of destinations and content sources. Therefore, previous systems cannot capture the user's activity across all of the user's devices. Accordingly, there is a need for systems that capture the entirety of a user's activity across a variety of devices.

Accordingly, there is a need for systems and methods for monetizing on-line advertising and data by users, as described herein.

### BRIEF SUMMARY OF THE INVENTION

To meet the needs described above and others, the present disclosure provides systems and methods for monetizing online advertising by users (referred to herein as “the consumer-controlled advertising system” or just “the system”). The consumer-controlled advertising system places consumers in control of the advertising they view while using a user device (such as a smart phone, personal computer, television, etc.) by permitting the consumer to control the personal information provided to advertisers, influence and approve the nature of the advertising that is displayed (or refuse the display of any advertising), and receive compensation for advertising and data that is displayed via the consumer-controlled advertising system, and data that is shared with advertisers.

In an embodiment, the consumer-controlled advertising system may replace advertising delivered to a user device with user-controlled advertising that is selected on the basis of the consumer's preferences. Additionally, the consumer may be compensated for allowing the insertion of the user-controlled advertising. By providing a consumer-controlled advertising system that includes consumer control and payment for participating, the present invention provides an advertising system that respects user-privacy, increases advertising conversion, and compensates consumers for participating. Using the system, consumers may select the types of ad content they want delivered to their various devices, as well as within the applications that run on those devices, and have the tools to monetize their interaction with advertisers that seek their attention. Thus, consumers are placed in a position to sell or auction their screen real estate to the highest bidder for the types of content they are willing to host.

For example, an individual user who wishes to enhance and monetize the advertising events that take place on his devices (as well as the data collection from those devices) may use the consumer-controlled advertising system with his user devices.

The consumer-controlled advertising system “represents” the consumer as a facilitator to create and service relationships with the vast array of vendors that are interested in sending to the consumer's suite of user devices and applications. The relationships may be managed for a single user of one or more devices, a family of users with separate accounts on common devices, a group of users with their own devices, or any other combination of users and accounts. The consumer-controlled advertising system provides a set of programmatic tools that allow the user to create and maintain a set of profiles for the user's desired media and data experiences, as well as maintain coordinated settings and programs that allow the consumer-controlled advertising system's proprietary tools to interact with the user's devices. The consumer-controlled advertising system may work with user devices such as desktop computers, mobile devices, cable television, satellite radio, smart watch, networked home automation devices, other networked personal devices, etc.

In an embodiment, the consumer-controlled advertising system includes a content proxy, a browser, and/or a browser extension, capable of suppressing embedded advertisements and replacing them with user controlled advertising content in the same location or in a different location on the user's screen. The consumer-controlled advertising system accommodates the flexible formatting that different users want. For example, rather than having a hodge-podge of co-mingled content and ads, a consumer may wish to separate published content originating from a news website from his user selected ad content. He could elect to get the same number of ads, but place them at different parts of the page. To facilitate these functions, the consumer-controlled advertising system provides real-time, simultaneous blocking and reformatting of the data that is coming from multiple sources (e.g., website, advertiser #1 sending a banner ad, advertiser #2 sending a banner ad, and advertiser #3 sending an ad video). The system is also capable of blocking ads altogether and reformatting the resulting text to fill the screen in a manner that the consumer has selected as a preference. The consumer-controlled advertising system may log various aspects of the user experience and store them in the remote user data storage database.

It is contemplated that the process of delivering relevant advertising content to user devices may be enhanced dramatically when each consumer and/or user device communicates thru a common gateway so that all of a consumer's (or family of consumers′) technology and media sessions are collected to create a consolidated user profile. Accordingly, regardless of whether content is modified by user device or routed through the content proxy, the consumer-controlled advertising system may develop a consolidated user profile spanning a group of consumers and user devices.

For example, the advertising opportunity can be enhanced even further when the consolidated profile is coordinated among all the user device of a consumer so that advertisers that target a specific consumer may recognize an event such as a click-thru on a user's desktop and subsequently, for example, send a video ad to the same user's mobile device to be followed by a related commercial on the user's cable system. The consumer-controlled advertising system provides enhanced methods and systems for cross-platform retargeting by creating a common gateway for multiple user devices.

Moreover, because each consumer is permitted to specify the types advertising content the consumer is willing and not willing to host on the user's various devices, it is believed that the advertising efficiency skyrockets for all interested parties and the consumer may enjoy an improved experience. Additionally, because a consumer is able to tailor types of content and subject matter the consumer is willing to host on his or her user devices, in the manner that he or she prefers to experience it, it is believed that impressions become more valuable and click-thru rates increase, resulting in revenue rate increases for reaching that consumer.

While the current ad channels might be reluctant to share in the revenue stream they generate from user device real estate they don't own, the pie will get bigger and the advertising channel will be more efficient by increasing the probability that a consumer will take action on the ad the consumer is presented simply because the consumer expressed an interest in the subject matter or brand. Because performance-based pricing (the “click-thru” model) accounts for two-thirds of ad placement, it is believed that the present system will increase click-thru rates, and consequently ad rates should rise dramatically when the consumer has input on what is sent to his or her screen.

In an embodiment, a user-controlled advertising system includes: a network interface in communication with a user device and one or more advertiser systems; user data storage including a user profile associated with the user device; a controller in communication with the network interface and the user data storage; memory in communication with the controller, the memory including instructions, that when executed by the controller, cause the controller to: receive a request from the user device identifying content from a content provider; retrieve the content from the content provider; identify first advertising in the content; send an advertising request to the one or more advertiser systems, the advertising request identifying demographic information from the user profile; receive, from the one or more advertiser systems, a set of prospective advertisements, wherein each prospective advertisement is associated with a rate; select an advertisement from the set of prospective advertisements associated with a highest rate; when the selected advertisement exceeds a reserve rate defined by the user profile; replace the first advertising with the selected advertising; and provide the content to the user device.

In some embodiments, the user-controlled advertising system further includes the instructions that cause the controller to: when the selected advertisement exceeds the reserve rate defined by the user profile, debit an account of an advertiser providing the selected advertisement in an amount of the reserve rate and credit the account of the user profile in the amount of the reserve rate.

In some embodiments, the advertising request includes reliability scores, wherein each reliability score is associated with an entry in the demographic information.

And, in some embodiments, the demographic information includes an age, gender, zip code, and a FICO score. Additionally, in some embodiments, the advertising request includes impending purchase information, wherein the impending purchase information indicates a category of a purchase, an expected purchase amount, and an expected purchase timeline. Further, in some embodiments, the advertising request includes ad content preferences including an ad content type.

In some embodiments, the advertising request includes a user behavior score, wherein the controller derives a user behavior score from an accessed content history of user devices associated with the user profile, wherein the user behavior score includes a value for an observed behavior in a category of goods and services.

For example, in some embodiments, the observed behavior is a click through frequency for advertising provided by the user-controlled advertising system in the category of goods and services. As another example, in some embodiments, the observed behavior is an online purchase frequency of goods and services in the category of goods and services.

In some embodiments, the controller further identifies dimensions of the first advertising, wherein the advertising request includes a request for advertising of the dimensions, wherein, upon receiving the set of prospective advertisements and before selecting the advertisement from the set of prospective advertisements associated with the highest rate, the controller removes from the set the prospective advertisements any prospective advertisements that fail to meet the dimensions. And, in some embodiments, upon receiving the set of prospective advertisements and before selecting the advertisement from the set of prospective advertisements associated with the highest rate, the controller removes from the set the prospective advertisements any prospective advertisements that fail to meet consumer defined preferences, wherein the consumer-defined preferences include desirable subject matter preferences and desirable ad type preferences.

In an embodiment, the user-controlled advertising system includes: an advertisement content gateway in communication with one or more advertiser systems; user data storage in communication with the advertisement content gateway, wherein the user data storage includes a user profile associated with the user device; a user device in communication with the advertisement content gateway and a content provider, wherein the user device receives content including first advertising from the content provider, wherein, in response to receiving the content, the user device makes a request to the advertisement content gateway, wherein, upon receiving a response from the advertisement content gateway including second advertising, the user device replaces the first advertising in the content with the second advertising and displays the content on a user interface of the user device; wherein, in response to receiving the request from the user device, the advertisement content gateway: sends an advertising request to the one or more advertiser systems, the advertising request identifying demographic information from the user profile, receives, from the one or more advertiser systems, a set of prospective advertisements, wherein each prospective advertisement is associated with a rate, selects an advertisement from the set of prospective advertisements associated with a highest rate, when the selected advertisement exceeds a reserve rate defined by the user profile, sends the selected advertisement to the user device as the second advertising.

In some embodiments, the user-controlled advertising system further includes a management interface that when the selected advertisement exceeds the reserve rate, debits an account of an advertiser providing the selected advertisement in an amount of the reserve rate and credits the account of the user profile in the amount of the reserve rate.

In some embodiments, the advertising request includes reliability scores, wherein each reliability score is associated with an entry in the demographic information.

And, in some embodiments, the demographic information includes an age, gender, zip code, and a FICO score. Additionally, in some embodiments, the advertising request includes impending purchase information, wherein the impending purchase information indicates a category of a purchase, an expected purchase amount, and an expected purchase timeline. Further, in some embodiments, the advertising request includes ad content preferences including an ad content type.

In some embodiments, the advertising request includes a user behavior score, wherein the controller derives a user behavior score from an accessed content history of user devices associated with the user profile, wherein the user behavior score includes a value for an observed behavior in a category of goods and services.

For example, in some embodiments, the observed behavior is a click through frequency for advertising provided by the user-controlled advertising system in the category of goods and services. As another example, in some embodiments, the observed behavior is an online purchase frequency of goods and services in the category of goods and services.

In some embodiments, a user-controlled advertising system includes: an advertisement content gateway; a management interface; a network interface in communication with the advertisement content gateway; a user interface; a controller in communication with the advertisement content gateway, the management interface, the network interface, and the user interface; memory in communication with the controller, the memory including instructions, that when executed by the controller, cause the controller to: receive content including first advertising in an advertising area of the content; receive a preference question from the management interface; replace the first advertising with the preference question within the advertising area of the content; display the content on the user interface; receive a preference from the user interface; receive second content including second advertising; send an advertising request to the advertisement content gateway, receive third advertising from the advertisement content gateway, wherein the advertisement content gateway selects the third advertising using the preference; replace the second advertising in the second content with the third advertising; and display the second content on the user interface.

An object of the invention is to provide a solution to existing systems that erode the privacy of consumers.

An advantage of the invention is that it provides an advertising system that provides consumers' control over the advertising they are exposed to and compensates them for the display of advertising on their devices.

Another advantage of the invention is that it provides a system that provides consumers direct and timely input to the advertising community with respect to what types of advertising to which the consumer is exposed. This provides considerable benefits the advertising community. A consumer's experience improves as the consumer is exposed to ad material that is more relevant to his or her preferences. Likewise, the ad industry also benefits as the probability of an ad's effectiveness increases dramatically.

A further advantage of the invention is that it may provide consumers participation in the substantial revenue stream that is being generated off of their devices. The systems and methods described herein provide a suite of technology tools and a process manager in order to provide access to this revenue.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an embodiment of a consumer-controlled advertising system including an advertising delivery module on a user device.

FIG. 2 illustrates an embodiment of a consumer-controlled advertising system including a content proxy.

FIG. 3A illustrates traditional content access using a user device. The content includes embedded advertising that is not requested by the user.

FIG. 3B illustrates content access using a user device of an example of the consumer-controlled advertising system with user-controlled advertising replacing embedded advertising in the content.

FIG. 4A illustrates an example profile screen of a management interface of an example consumer-controlled advertising system for inputting user preferences.

FIG. 4B illustrates consumer defined preferences may be requested from the consumer by replacing embedded advertising with a user preference prompt.

FIG. 5 illustrates an advertiser content response process for selecting user-controlled advertising for inclusion in content.

FIG. 6A illustrates an example process for a user or group search that may be performed by an advertiser to find users or groups to target advertising toward.

FIG. 6B illustrates an example process for targeting advertising toward a user or group.

FIG. 7 illustrates an embodiment of a consumer-controlled advertising system.

FIG. 8A illustrates the logical structure of information in an example profile message.

FIG. 8B is a legend explaining an example encoding for various data categories of the profile message.

### DETAILED DESCRIPTION OF THE INVENTION

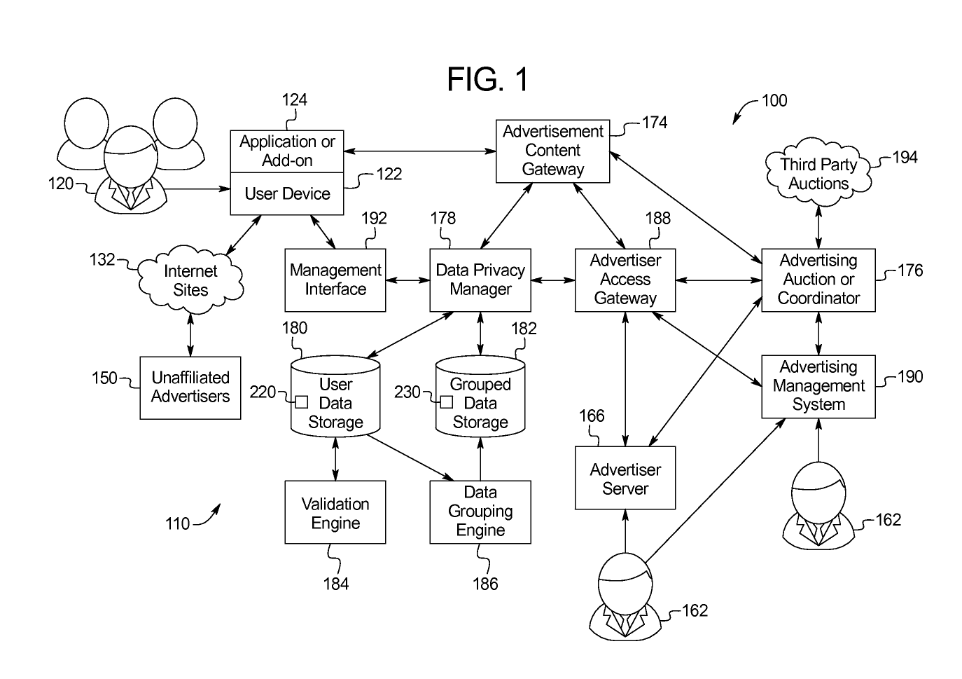

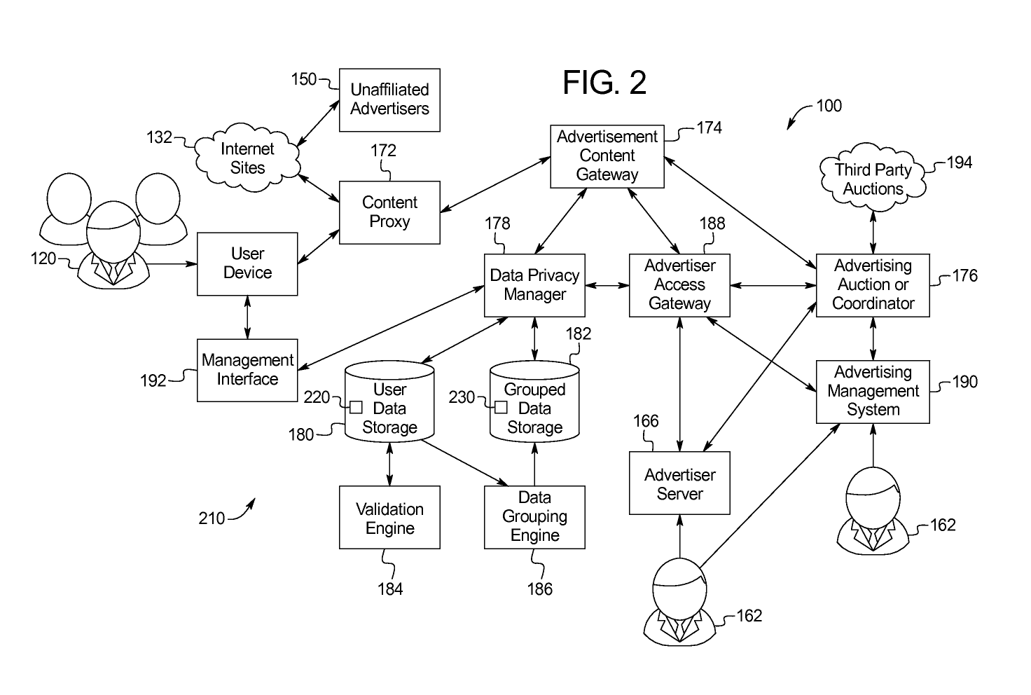

FIGS. 1 and 2 illustrate embodiments of a consumer-controlled advertising system 100. As shown in both FIGS. 1 and 2, a consumer 120 using a user device 122 may access content 130 from a content provider 132, such as an Internet website. The content 130 may include embedded advertising 140 from unaffiliated advertisers 150 unaffiliated with the consumer-controlled advertising system 100. The consumer-controlled advertising system 100 may suppress the display of the embedded advertising 140 and replace it with user-controlled advertising 160 from advertisers 162 affiliated with the consumer-controlled advertising system 100. To encourage consumer participation, the fees paid by the advertisers 162 to advertise via the system 100 may be shared with the consumers 120. In some embodiments, consumers 120 may choose to forfeit the fees and have no advertisements shown in the content 130. Advertisers 162 may include advertisers, agents, third party auctions or systems, etc. Further, the functionality described herein for use by advertisers 162 may additionally be used by data collectors, researchers and other parties who are not traditional advertisers, and it will be understood by those of ordinary skill in the art that advertisers 162 includes those parties also.

In a first embodiment 110, shown in FIG. 1, the consumer-controlled advertising system 100 suppresses embedded advertising 140 at the user device level. As shown, the user device 122 may include an advertising delivery module 124 that performs various functions of the consumer-controlled advertising system 100. In an embodiment, the advertising delivery module 124 may detect embedded advertising 140 within the content 130 received from content providers 132. The advertising delivery module 124 may remove the embedded advertising 140 and replace it with user-controlled advertising 160. In an embodiment, the advertising delivery module 124 is an application running on the user device 122, for example, it may be an application, browser extension, operating system add-on, etc. To carry out its functions, the advertising delivery module 124 may communicate with remote servers running other software modules of the consumer-controlled advertising system 100, such as a management interface 192 or the advertisement content gateway 174.

In a second embodiment 210, shown in FIG. 2, the consumer-controlled advertising system 100 suppresses embedded advertising 140 using a content proxy 172. The consumer 120, the device manufacturer, or another party may configure the user device 122 to route all traffic with content providers 132 through the content proxy 172. The content proxy 172, in turn, may detect embedded advertising 140 within the content 130, remove the embedded advertising 140, and replace it with user-controlled advertising 160.

In further embodiments, the system 100 may include: user devices 122 including an advertising delivery module 124; and a content proxy 172 for user devices 122 with no advertising delivery module 124. Further, in some embodiments, the advertising delivery module 124 and the content proxy 172 may interoperate and the functionality described herein for each may be included in the other in some embodiments. For example, in an embodiment, the advertising delivery module 124 may communicate a reference to the content 130 to the content proxy 172 and receives back from the content proxy a determination of the location of the embedded advertising 140 and instructions on the placement of user-controlled advertising 160.

As noted, content 130 may be rerouted through a content proxy 172. The content proxy 172 may use filtering logic to determine which content 130 to replace and which content 130 to leave unaltered. For example, for web content, the filtering logic may inspect the source code of the content 130 to locate tags (such as iframe, img, etc.), JavaScript, CSS etc., referencing advertising or other undesired content from domains that match a list of known advertisers, ad brokers, etc. The content proxy 172 may record the content details of the embedded advertising 140, such as it's rendered size, location, layering over or under other content, opacity, media type, etc. When replacing the embedded advertising 140, the content proxy 172 may insert the user-controlled advertising 160 into the content with content details that match or substantially match the content details of the embedded advertising 140. Alternatively, the user-controlled advertising 160 may be inserted in accordance with page layout preferences 450 provided by the consumer 120.

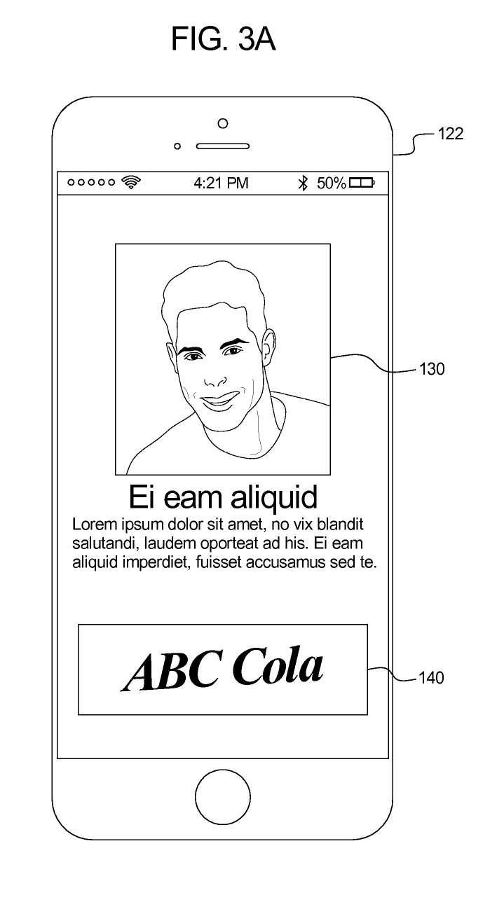

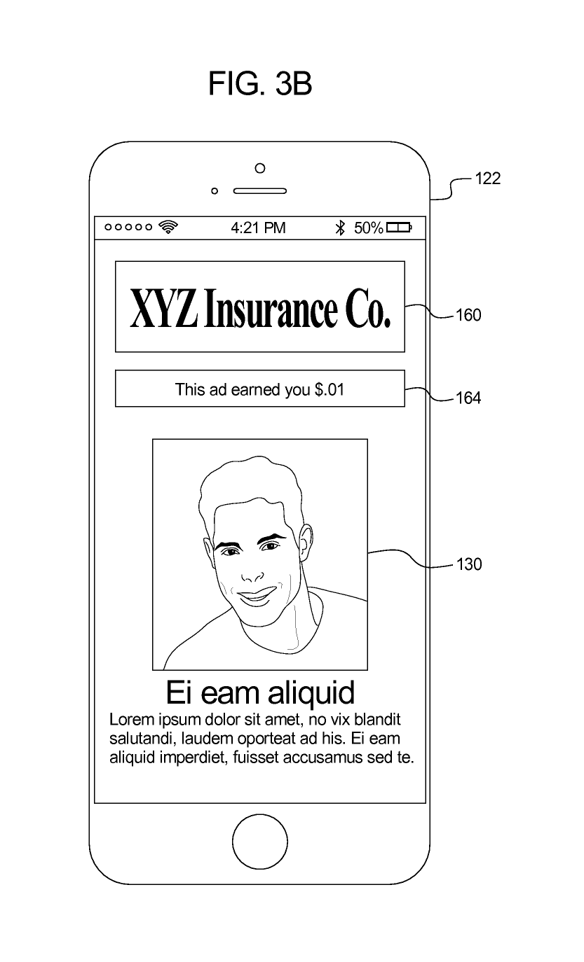

FIG. 3A illustrates traditional content access using a user device 122. The consumer 120 may access content 130. The content 130 may include embedded advertising 140 in-line with the content 130. The embedded advertising 140 benefits the content provider 132 but does not benefit the consumer 120, the owner of the user device 122. Additionally, the unaffiliated advertisers 150 providing the embedded advertising 140 are limited in their capacity to target consumers 120 or to know to what extent the consumer 120 has actually viewed the embedded advertising 140.

Accordingly, FIG. 3B illustrates a user device 122 of the consumer-controlled advertising system 100. As shown, the embedded advertising 140 has been removed and replaced by user-controlled advertising 160 as may be accomplished by the content proxy 172 or the advertising delivery module 124. The user-controlled advertising 160 may be selected by matching consumer-defined preferences 405 to an advertiser bid 520. Additionally, the user-controlled advertising 160 may be selected and placed in the content 130 in accordance to the consumer's page layout preferences 450. As shown in FIG. 3B, the user-controlled advertising 160 is placed at the top of the content 130, rather than in the middle of the content 130 as the embedded advertising 140 is placed in FIG. 3A. To provide consumer engagement with the user-controlled advertising 160, a payment message 164 may be displayed on or near the ad (for example, on hovering over the ad) to inform the consumer 120 of the value earned by engagement with the user-controlled advertising 160.

Although described with respect to a banner ad in FIGS. 3A and 3B, advertising, as used herein, may refer to a wide variety of advertising types across a wide type of user devices 122. For example, advertising may include browser banner, interactive flash ads, as well as mobile ads, video ads, radio ads, television commercials, native ads, special offers, email solicitations, push notifications, surveys, sponsored content, etc.

Additionally, embedded advertising 140 may include portions of content 130 not easily identified as embedded advertising 140. For example, certain items on a search result page may in fact be ads because the search engine is paid directly for displaying it among the item amongst its search results. This embedded advertising 140 may be replaced by the system 100 as described herein and replaced with user-controlled advertising 160 that may be relevant to the search term(s) and in line with their pre-defined preferences.

Currently, when a user clicks on a search result that redirects a browser to a website, the search engine may receive compensation from the destination site. Because a search result is much like an ad, the system 100 may reward users for clicking a search result. For example, if the destination site is an advertiser 162 in the system, the compensation may be a direct payment from the advertiser 162, or a percentage of sale prices if, for instance, the re-direct results in a transaction from the advertiser 162. The system 100 may algorithmically screen search results using the consumer defined preferences 405 and suppress certain line items results that do not meet the payment criteria of the consumer's rate settings 460. Payment criteria in this case may take the form of direct compensation to the consumer 120 on a per click model from the search engine or the vendor, or in a rebate/discount on a purchase that is linked to the click-thru. A similar process may be used for destination pages that have no content but act as a re-direct hop to an actual content provider/vendor.

Moreover, embedded advertising 140 may include in-app advertising. Many applications such as Pinterest, Twitter, Instagram, Vine, Facebook, YouTube, Spotify, and Reddit, as well as gaming applications, etc., sell a consumer's screen space to advertisers. This space becomes more valuable to all when the consumer 120 has a means to create an acceptable user profile 220 indicating which ads the consumer 120 is willing to accept. Accordingly, the advertising delivery module 124 may interface with application of the user device 122 to replace embedded advertising 140 with user-controlled advertising 160. In an embodiment, the advertising delivery module 124 may include operating system extensions, application programming interfaces, or other low-level integration with applications to permit the consumer-controlled advertising system 100 to provide user-controlled advertising 160.

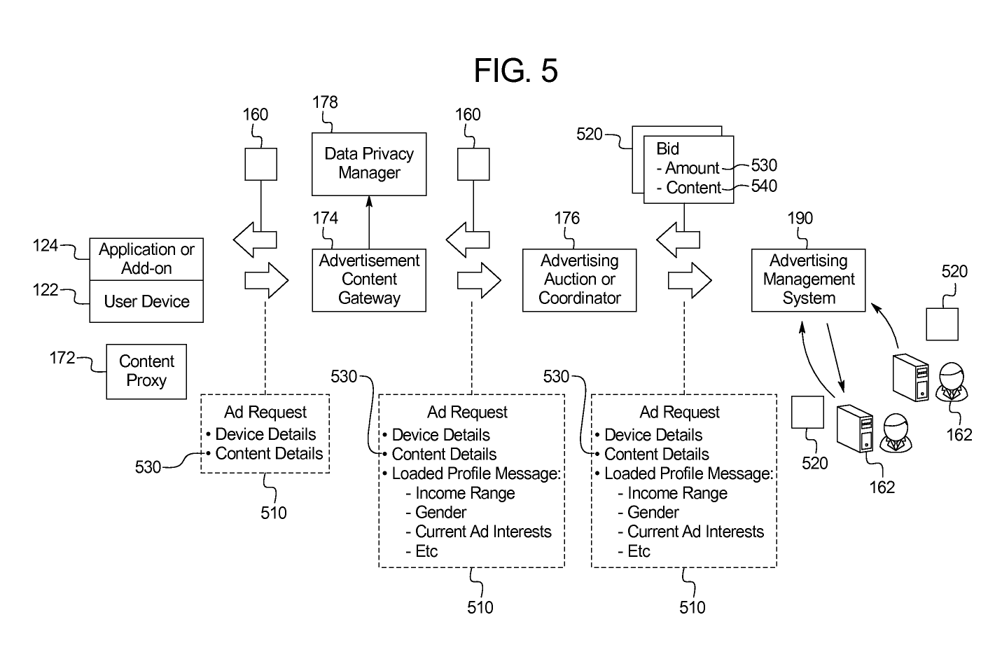

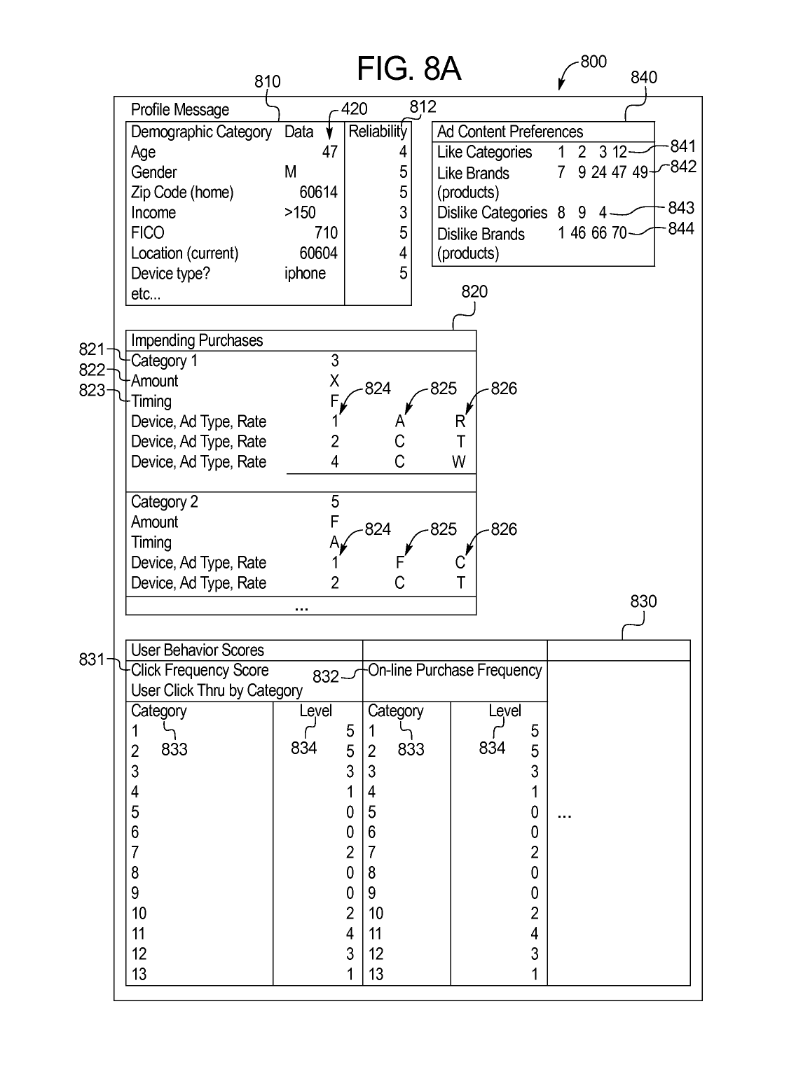

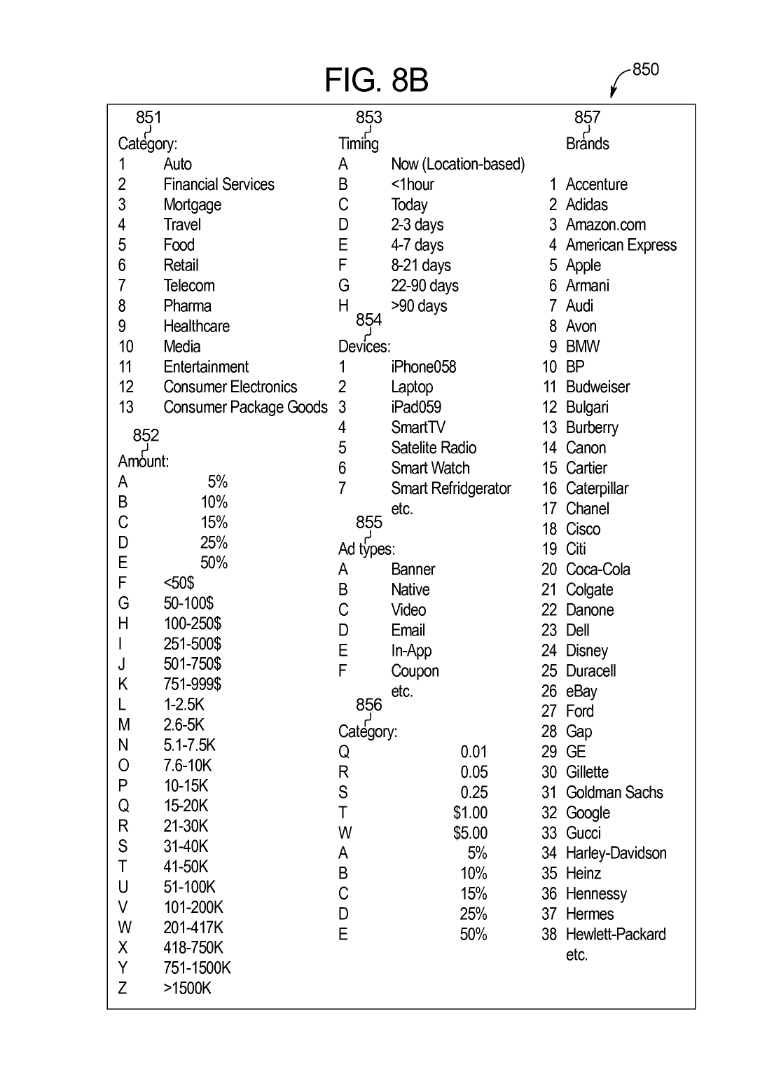

Advertising requests 510 (or just ‘ad requests,’ as shown in FIG. 5) may be routed through an advertising content gateway 174. The advertising content gateway 174 loads any additional permitted data from the user profile 220 via the data privacy manager 178 to augment the advertising request 510 with permitted user profile information, such as the profile message (FIGS. 8A and 8B). The advertising content gateway 174 then sends the augmented advertising request 510 to the advertising auction or coordinator 176 to select user-controlled advertising 160. The user-controlled advertising 160 from the advertising auction or coordinator 176 is then served back to the consumer 120 by the advertising content gateway 174.

The advertising content gateway 174 may recognize what type of device from which an ad request 510 originates, and reformats and forwards the ad request 510 so that it may readable by their destination interfaces. For example, an ad request 510 may be sent to one or more destinations including ad placement engines, third-party ad auction engines, application vendors, content providers 132, etc. The advertising content gateway 174 may request advertising 160 that meets the consumer defined preferences 405 for category, type, size, length, rates 462, etc.

The advertising content gateway 174 may determine which advertising 160 that has been returned will be accepted, and may then format the advertising 160 according to the consumer's page layout preferences 450 along with the content 130 returned from content providers 132. The advertising content gateway 174 may determine how to co-mingle various ad types and subject matter (alternatively, this may be accomplished by the advertising delivery module 124 or the content proxy 172). The resulting combined and formatted content pages may then be displayed the user device 122.

An advertising auction or coordinator 176 may transmit ad requests 510 to advertisers 162 and select from the responses of these parties to determine what user-controlled advertising 160 to serve to the consumer 120. For example, the advertising auction or coordinator 176 may conduct an auction by matching an ad request 510 to the best-received bid 520. Additionally, the advertising auction or coordinator 176 may integrate with third parties systems or auction systems to select user-controlled advertising 160 to serve to the consumer 120. The advertising auction or coordinator 176 may also settle the balances between advertisers 162 and consumers 120 after user-controlled advertising 160 is selected and displayed on a user device 122.

A data privacy manager 178 may arbitrate all access to consumer and group data (both reading and writing) and enforces permissions on who can read, write, and distribute personal data. The data privacy manager 178 may allow consumers 120 and the consumer-controlled advertising system 100 to set policies to limit what user profile 220 may be stored, read, and distributed. User-editable policies may define who can access data, read data, store data, and distribute data. The data privacy manager 178 may connect to user and group data sources and help to limit direct access to those sources.

User data storage 180 may include one or more data stores that contain a user profile 220 for a consumer 120 that include personal data, consumer preferences, consumer history, etc. The user data storage 180 may include different access methods or indexes to enable more efficient or effective access of the data in user profiles 220. The user profile may include the consumer defined preferences 405, device information 410, demographic information 420 (and validated demographic information 810), desirable subject matter 430, desirable ad types 440, page layout preferences 450, rate settings 460, impending purchase information 820, user behavior scores 830, ad content preferences 840, etc. The user profile 220 may additionally include data on the consumer's history with the system 100, for example, the user profile 220 may include the consumer's browsing history, search history, click-through history on various ad types, consumer interests, on-line purchase frequency, average time between searches and purchases, the number of review sites visited for a product or category, the number of reviews clicked or visited by a user prior to purchase, etc.

Further, the user profile 220 may store personal data, such as, the consumer's web surfing history, the device use history, the content consumption history of the consumer 120; cookies permitted by user devices 122; profiles for each user device 122 and a consolidated user profile for all user devices 122; micro-transaction accounts and receivable/payments history of consumer 120 from the display of consumer 120; ad auction historical information; rates 462; etc. Any data in the user profile 220 may be permissioned to control which parties may read, write and distribute the data, permissions may be made for the type of use (consumer research, advertising, etc.); the category of the user (i.e., insurance companies, car companies, food service companies, etc.); or specific brands (i.e., American Motors, First Bank of Chicago, etc.); etc.

The intent of the consumer profile message 800 is to create common, industry accepted, enhanced message format that will improve advertiser efficiency in reaching its most desirable audience, thereby potentially improving the overall success of the advertising effort at a lower cost per successful outcome.

In some embodiments, the content providers 132 may receive the consumer profile. A consumer profile message 800 (FIGS. 8A and 8B) may travel with each ad request 510, or along with other activities, such as a website visit, channel change, app purchase, screen refresh, or ad request 510. As described below, this profile message 800 may contain information similar to what currently travels from a “cookie” including device type, but is enhanced with things like: a validated profile reliability scores in certain categories; specific user ad preferences and/or our proprietary user preference scores in different ad subject, ad type, and ad placement categories; rate data to the extent that the user has set rates for various types of ad placements on his screen; and auction trigger message to the extent the consumer 120 wishes to initiate an auction for available ad space on his user device 122.

The grouped data storage 182 may include one or more databases that contain grouped profiles 230. Grouped user profiles 230 may include data aggregated from the user profiles 220 of multiple consumer 120, systems, etc. The grouped data storage 182 of grouped profiles 230 may include different access methods or indexes to enable more efficient or effective access of the stored data. In an embodiment, families of consumers 120 may use grouped profiles 230. Since consumers 120 in a family or other group may share user devices 122, the particular consumer 120 using a user device 122 may vary; accordingly, a grouped profile 230 may include multiple consumers 120 and multiple devices 122. In an embodiment, a grouped profile 230 may include consumer-defined preferences 405 that may apply wherever a corresponding preference is not defined for a particular profile in the group. The system 100 may attempt to determine which consumer 120 is using a particular user device 122 at a given time in order to permit effective targeting. In an embodiment, the system 100 may correlate a consumer's content consumption to the consumer 120 to make a determination that a particular consumer 120 of the group is on a particular user device 122. It will be understood by those of ordinary skill in the art that the functionality described herein for a consumer profile 220 may be applied equally to the grouped profiles 230.

A validation engine 184 may attempt to validate the claims a consumer 120 has made about his or herself against the personal data the system has for that consumer 120. The resulting validated profile enhances the reliability of the information supplied and, therefore, is potentially more valuable to advertisers 162 who may then more efficiently target certain types of consumers 120. Confirming the reliability of the zip code, FICO score, marital status, current location, income, etc. increase the value of information for an advertiser considering what to pay for ad space on a user device 122.

The validation engine 184 may help prevent fraud incentivized by the payments to the consumer 120 for viewing ads. The validation engine 184 may use various analytical techniques to try to find exceptions to a consumer's claims to prevent consumers 120 from affecting the system with inaccurate data. For example, the validation engine 184, where possible, validates various pieces of profile information against third party source data and/or the consumer's historical information. For each entry in a user profile 220, the system 100 may assign a reliability confidence level 812 (FIG. 8A). For example, based on the level of validation, a profile reliability scores for various categories of user profile information may be generated and supplied to the marketplace, for example, as a part of an ad request 510.

As another validation technique, the validation engine 184 may validate entries in the user profile 220 against the consumers' content consumption. For example, if the web browsing habits of user profile 220 for a forty-year old man match the expected behavior of a fourteen year old girl, the system 100 may assign a low reliability confidence level 812.

A data-grouping engine 186 may group consumers 120 and system data in various ways to create additional aggregated interpretations of the personal data in the consumer-controlled advertising system 100. The data-grouping engine 186 may use various matching techniques to create these groupings based on the most effective matching type for the type of data it is grouping.

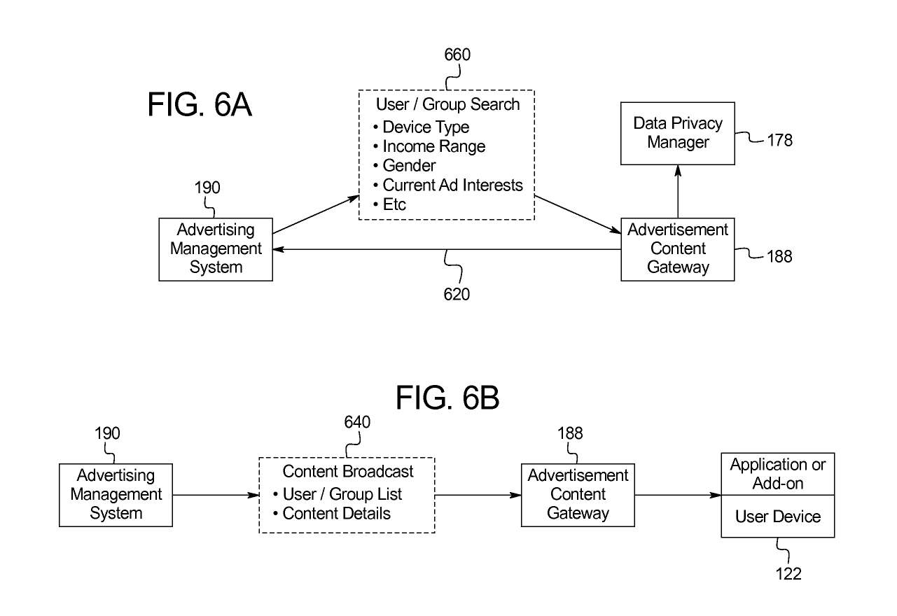

An advertising access gateway 188 may provide other internal systems or advertisers 162 access to permissioned user data, mechanisms to broadcast offers, etc. The advertising access gateway 188 may provide a programmatic API that will allow advertisers 162 to access consumer data in a controlled manner and integrate the access into their customized systems, as shown, for example, in FIGS. 6A and 6B.

An advertising management system 190 may provide advertisers 162 a mechanism to interact with the overall system 100 without needing to develop customized software themselves. For example, the advertising management system 190 may provide advertisers non-programmatic ways to access data, precondition desired responses to auctions, view results, etc. Advertisers 162 may access the advertising management system 190 to accomplish a number of tasks, such as: making bids 520 (FIG. 5); analyzing data of one or a group of consumers; measuring efficiency/utility/value of ads or data; etc. The advertising management system 190 may provide a front-end user interface for advertisers 162. In some embodiments of the invention, the advertising management system 190 may provide an application program interface (API) for users who desire customized access to the system and data.

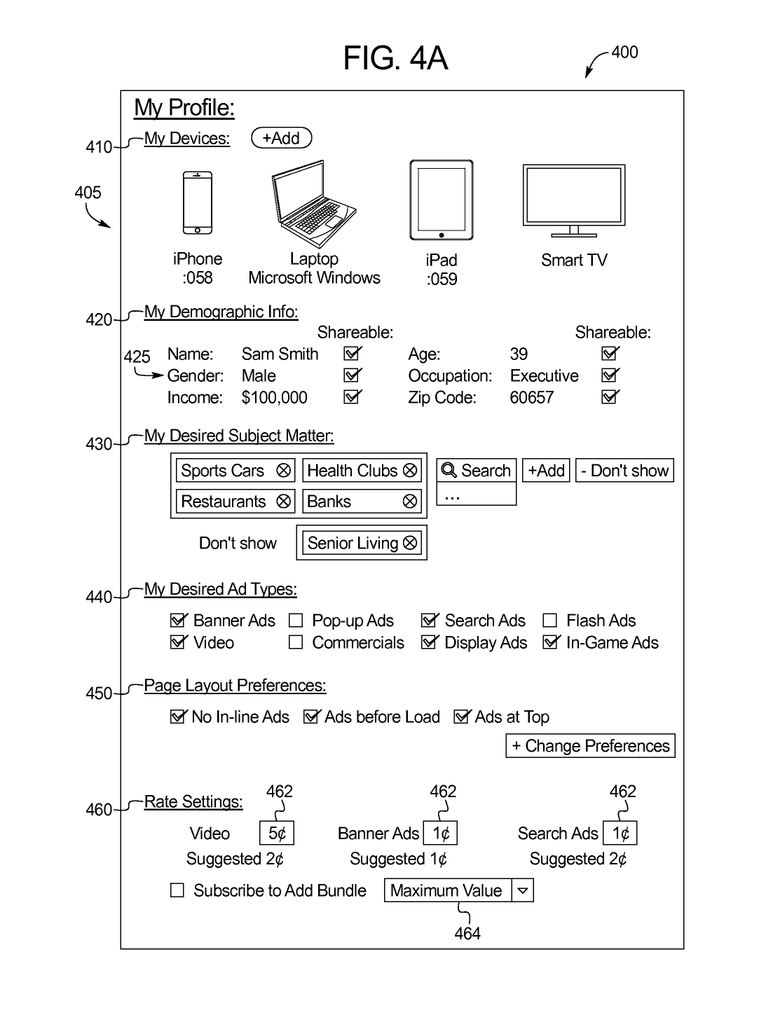

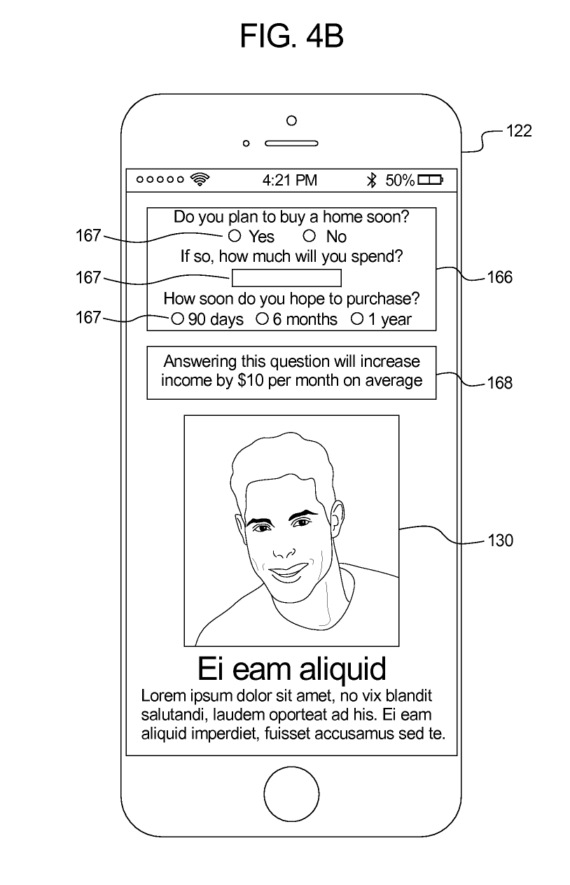

A management interface 192 provides consumers 120 with a mechanism to view and modify their settings or account details. The management interface 192 may provide the consumer 120 a non-programmatic straightforward way to manage the any details related to their interaction with the system 100. The management interface 192 application may run as a software program resident on the user device 122 and/or as a secure website. The management interface 192 may include a user interface that displays a list of relevant user devices 122 and allows a consumer 120 to input how she wants to manage the content 130 delivered to her various user devices 122. For example, as shown in FIG. 4A, the consumer 120 may access a profile screen 400 of the management interface 192 to input various consumer defined preferences 405, such as, device information 410, demographic information 420, desirable subject matter 430, desirable ad types 440, undesirable subject matter, undesirable ad types, page layout preferences 450, rate settings 460, etc.

Additionally, as shown in FIG. 4B, consumer defined preferences 405 may be requested from the consumer 120 by replacing embedded advertising 140 with an information prompt 166. The information prompt 166 may include user inputs 167 that may be used to update the consumer-defined preferences 405. In the embodiment, the information prompt 166 queries the user regarding an impending purchase of a home or mortgage. As shown, the information prompt 166 asks whether a purchase is planned and the amount and timing of the purchase. Additional examples of an information prompt 166 may include questions regarding the consumer's desirable subject matter 430 for ads; for example, the information prompt 166 may inquire, “Would you like to receive advertising from car companies?” As another example, the user preference prompt 166 may ask the consumer 120 to input his favorite type of cuisine (“French”, “Mediterranean”, “Asian”, etc.). The information prompt 166 may include freeform text inputs, slider inputs, radio buttons, etc. As another example, if the user has indicated that he likes “baseball,” the user preference prompt 166 may ask the consumer 120 to rate the preference on a scale of one to ten.

In order to encourage the consumer 120 to answer the information prompt 166, the information prompt 166 may include an incentive 168. For example, as shown, the incentive 168 promises the consumer 120 that “answering this question will increase income by ten dollars per month on average.” In an embodiment, the incentive 168 may be calculated by the system 100 by determining the average increase in value of the consumer's user profile 220 over a period of time based on all possible answers. Alternatively, in another embodiment, the incentive 168 may be calculated by the system by determining the minimum increase in value of the consumer's user profile 220 over a period of time based on any possible answer provided. In such an embodiment, the incentive 168 may inform the consumer 120 that “answering this question will increase income by at least five dollars per month.” Even further, in an embodiment, the incentive 168 may be calculated by the system by determining the maximum increase in value of the consumer's user profile 220 over a period of time based on any possible answer provided. In such an embodiment, the incentive 168 may inform the consumer 120 that “answering this question will increase income up to twenty dollars per month.”

As previously described the incentive 168 is text, audio, video, etc. illustrating the potential returns to future ad viewing by providing user information. It is contemplated that the system 100 may be more direct and offer direct incentives 168. For example, in response for answering queries, providing preferences, correcting demographic data, etc., the system 100 may compensate the consumer 120 with alternative compensation, such as: immediate payment in the form of the currency used for the system; an increased consumer score (and, in turn, rankings within the system to provide the psychological benefit of a consumer 120 having a high score or not wanting a low score); a status level credit within the system (like status on an airline); a status level credit within a category or brand (the champion of American cars or the mayor for Audi®); unlocking exclusive deals and coupons; free products or subscriptions (ex. free apps, free internet, etc.); access to exclusive content, features, products, or services of an advertiser; free access to protected or commercial content (ex. being able to read an article behind a pay wall); access to protected or commercial features of the system 100; charitable contributions; giveaway or contest admission; etc. Further, it is contemplated that any compensation provided by the system 100 for any purpose may be provided as an alternative compensation.

Device information 410 may include a list of user devices 122 associated with the consumer 120. The device information 410 may additionally include a list of operating systems, applications, settings, such as privacy settings, etc., related to the user devices 122. For example, a user profile 220 may have device information for his mobile device, additional device information for his laptop computer, and device information for his smart television.

Demographic information 420 may include consumer-defined demographic profiles to be shared with advertisers 162 and other various types of data consumers. The management interface 192 may permit the consumer 120 to define those demographic traits 425 that may be shared. Demographic information 420 may include the consumer's name, age, location, gender, income, spending profile, browsing habits, FICO score, etc. In some embodiments, the consumer 120 may define the sharing of demographic traits 425 at the category of firms level or at the individual firm level.

For instance, in some embodiments, the systems and methods provided herein may permit sharing of income with a mortgage company, but not with manufacturer of consumer goods. A consumer 120 may also want to create a different demographic profile to be shared from different types of user devices 122. For instance, a consumer 120 may share the fact that she is a vegetarian for data distributed from her phone in the hope of receiving a location offer from a vegetarian restaurant as she walks down the street, but would not be interested in having that information shared with cable television advertisers.

Desirable subject matter 430 is consumer-defined preferences 405 specifying the advertising subject matter for which a consumer 120 is willing to accept user-controlled advertisements 160. For example, a 30 year-old single man may want to receive ads in categories such as sports cars, health clubs, financial institutions, and restaurants. He may not wish to host ads for senior living facilities and bladder control medications. Additionally, he may prefer to get a restaurant ad on his phone, particularly if the restaurant is near his current location, but would not want the same ad to appear on his cable TV. Similarly, the consumer 120 may block specific vendor ads (e.g., Taco Bell) without blocking the entire category (e.g., fast food). As shown from the examples described, desirable subject matter 430 may be expressed per-device, on a category of business basis, or a per-company basis.

Similarly, desirable ad types 440 are consumer-defined preferences 405 specifying the nature of ads for which the consumer 120 is willing to accept. For example, he may prefer a video ad for the sports cars category and a banner ad for the financial institution category. Additionally, the consumer 120 may accept video ads on his cable TV and desktop computer, but only wishes banner ads to appear on his smartphone. Further, desirable ad types 440 may include settings to limit ad frequency and length.

Further, page layout preferences 450 are consumer-defined preferences 405 that permit the consumer 120 to input where in the content 130 different types of user-controlled advertising 160 are to be placed and how many user-controlled advertisements 160 are to be placed. The page layout preferences may be expressed for each user device 122, browser applications, television screen, etc. For example, a consumer 120 may be willing to host a video ad on a browser homepage, but only banner ads on successive pages. Page layout preferences 450 may define the location, size, number, and type of user-controlled advertising displayed. Page layout preferences 450 may be reactive to the existing page layout. For example, for web content 130, a consumer 120 may select a preference of a “minimization mode” that may be accomplished by removing the embedded advertising 140 and inserting Javascript or other reactive code into the web page to dynamically locate the user-controlled advertising 140 in a manner that minimizes the distraction relative to the elements present in the page. Alternatively, a consumer 120 may select a preference of an “ads first mode” that inserts Javascript or other reactive code into the web page to dynamically display the user-controlled advertising 160 in a layer above the rest of the page while the rest of the page is loading and rendering, and then removes the user-controlled advertising 160 once the page is fully-loaded.

Rate settings 460 are consumer-defined preferences 405 for the compensation (either in currency or some other form of remuneration) for viewing ads on the consumer's user devices 122. A consumer 120 may specify varying rates 462 for: different types of ads (banner, video, in-app, etc.); different devices (e.g., television ads may require a higher payment than mobile device ads); different ad categories (fast food, automobiles, insurance, etc.); different page locations at which the ads will render (e.g., ads at the top of the page may require higher payments versus ads on the side of the page or the bottom of the page); different page hierarchy (homepage vs. successive pages); different times of day or week or year at which the ad will run; different video length and ad frequency; and different rates to specific vendors (e.g., user is only willing to host an ad for Taco Bell if they pay two times the category rate for fast food vendors).

The rates 462 may act as a reserve price for advertising of the type specified by the rate 462. Each ad request 510 may specify the rate 462 provided by the consumer 120. If more than one advertiser 162 is willing to pay the rate set by a consumer for an ad request 510, a high-speed auction may determine which advertiser's advertising is displayed as the user-controlled advertising 160. Additionally, it is contemplated that the consumer 120 may choose to have rates 462 set entirely by an auction process to let market rates maximize the amount the consumer 120 receives. Further, the consumer 120 may choose to have the system 100 to manage the rates 462.

It is contemplated that subscribing to customized ad bundles 464 may set rates settings 460. For example, a consumer 120 may select to pre-sell some or all of his available ad space in a bundle 464 for a period of time and rely on the system 100 to place those ads on appropriate user devices 122 throughout the period. (e.g., Audi may wish to send you fifty ads during the month to be allocated among the user devices 122). These bundles may be from a single advertiser 162 or a group of advertisers 162 in the system 100.

Ad bundles and multi-device ad bundles 464 may be selected by the consumer 120 to permit the system 100 to manage the contracts of the consumer 120. This may permit a manager of the system 100 to pre-sell some or all of the future device ad space for a set amount of time to an advertiser, ad placement firm, advertising conglomerate consisting of multiple advertisers, or another interested party. In an embodiment, the system 100 may group one or more customers 120 into audience groups based on their user profiles 220 and market the audience groups as a unit for a specified length of time with a pre-described number of ad instances at random or specific times throughout the cycle. The ad bundles 464 may be sold via a manual and/or automated broker arrangement. By providing ad bundles 464, the system 100 simplifies the consumer's management process for selling ad content on his user devices 122; and locks-ups ad relationship(s) for a set amount of time between a specific, valued customer base and one or more advertisers.

Once sold, the placement of ads from the ad bundle or multi-device ad bundle 464 may be managed by the advertisement content gateway 164, which may include proprietary algorithms to determine when and where in the content 130 to place the remaining user-controlled advertising 160. In the case of an application vendor, such as a gaming application, an ad bundle 464 may be sold to the vendor or vendor agent at the time the app is purchased, when a session is initiated on the device, and/or at a screen transition interval while the app is running.

It is anticipated that as part of the service, the consumer-controlled advertising system 100 may electronically suggest marketable rates 462 to consumers 120 for various media ad types and subject matter categories using data from its proprietary customer database as well as industry published data. The consumer-controlled advertising system 100 may negotiate more favorable rates 462 for ads that it can prove were interacted with. (e.g., a video that is watched to completion is more valuable than one that is not.)

The management interface 192 may additionally be used by the consumer 120 to access data, such as, revenues (or other benefits) generated by the consumer's activity. Revenues may be described in summary, by user device 122, consumer, as well as by transaction. In some embodiments, consumer compensation may take a form other than a currency payment. For example, in some embodiments, a points system, gift card, or other economic benefit that is exchangeable for some value to the consumer 120 will be the “currency” that is exchanged between advertiser 162 and consumer 120. The management interface 192 may also include an accounts receivable/account payable due to consumer and payment transaction history. And, the management interface 192 may further include summary data related to interaction history in total and by user device 122 and consumer 120 (e.g., number of web pages visited per time period, broken down by category, number of ad impressions, number of click-throughs, television hours in summary and by channel, ad information related to television viewing, radio listening hours in total and by channel, ad information related to radio, etc.).

Turning to FIG. 5, in order to replace embedded adverting 140, the advertising delivery module 124 or the content proxy 172 may transmit an ad request 510 to the advertisement content gateway 174. The ad request 510 may include device details identifying the user device 122 and content details 530 including properties of the embedded advertising 140 to be replaced. Content details 530 may include the dimensions of the embedded advertising 140, the presence of any media, such as images or video, information identifying the source of the embedded advertising 140, such as domain names, or content networks etc.

Upon receiving an ad request 510, the advertisement content gateway 174 may load permitted user data from the user profile 220, such as demographic information 420, desirable ad types 440, page layout preferences 450, etc., as permitted by the consumer-defined preferences 405. The user data may be included in a profile message 800 in the ad request 510 and may be forwarded to the advertising or auction coordinator 176 to conduct an auction. The advertising or auction coordinator 176 may conduct an auction by forwarding the ad request to advertiser's servers to solicit bids 520 to fill the advertising request 510.

Each bid 520 may include an amount bid 530 and advertising content 540 to be displayed as user-controlled advertising 160 if the bid succeeds. The advertising or auction coordinator 176 may select a winning bid 520 and forward the user-controlled advertising 160 to the user device 122 for display. Bids 520 may additionally specify advertiser preferences, such as the desired ad type to display (banner, popup, search, etc.), device preferences, demographic preferences, data validation preferences (i.e., targeting only to those who meet verified demographic requirements), etc. It is contemplated that bids 520 may include targeting entries for every kind of data stored in the user profile 220, include data concerning the user's history, etc.

In some embodiments, the advertiser 162 may pre-define bids 520 using the advertising management system 160. When the advertising or auction coordinator 176 conducts an auction, it may include the pre-defined bids 520. Additionally, it is contemplated that, in an embodiment, the user data from the user profile 220 and consumer-defined preferences 405 are scored so that when such scores are transmitted to an advertiser 162, the advertiser 162 may electronically determine what ad requests 510 for which they wish to compete.

In an embodiment, an advertiser 162 may desire to broadcast advertising to a desired set of consumers 120 or research consumer profiles as a part of an advertising campaign or to research consumers 120 for purposes other than advertising. As shown in FIG. 6A, the advertiser 162 may input a user or group search 610 into the advertising management system 190. The search 610 may include characteristics of desired consumers 120 to target ads to, such as, device type, income range, gender, current ad interests (as specified by the desirable subject matter 430, desirable ad types 440, page layout preferences 450, etc.), impending purchases, user behavior scores, rate settings 460, etc. The data privacy manager 178 may perform the search 610 and, if permitted by each consumer's defined preferences 405 may send the results 620 back to the advertiser 162 or store the results as a targetable group. The search results 620 may include any information from a consumer's profile 120 that the advertiser 162 is permitted to access.

A consumer 120 may define rate settings 460 for access to his or her data. When accessing the data, the advertiser 162 may elect to pay the consumer's defined rate. For example, when running the group search 610, the advertiser 162 may indicate that it is willing to pay fifty cents for each profile returned. The data privacy manager 178 may determine, while making the search, those profiles with rate settings below the advertiser provided rate and include those consumer's data as a part of the search results 620. For those consumers 120 who have a higher rate in their rate settings 460, the advertiser 162 may be denied their data in the search results 620.

After running a group search 610, the advertiser 162 may then, as shown in FIG. 6B, target the targetable group with an ad broadcast 640 including a group list, content details, and advertising content. In response to an ad request 510, the advertising content may be selected by the advertisement content gateway 174 and forwarded to the user device 122 for display as user-controlled advertising 160. Alternatively, the advertising content may be pushed to the consumer 120, for example, via email, text message, etc.

To increase the efficiency of ad placement, each ad request 510 may include a profile message 800 that permits advertisers 162 to profile the consumer 120. FIG. 8A illustrates the logical structure of information in an example profile message 500. As a reference, FIG. 8B is a legend explaining the encoding of the profile message of FIG. 8A. A profile message 800 may be delivered in a standardized format that is designed to permit efficient evaluation of the ad request 510. For example, in an embodiment, a profile message 800 may be encoded in an XML document that abides by a schema for profile message documents.

In an embodiment, the profile message 800 may include validated demographic information 810, impending purchases 820, user behavior scores 830, ad content preferences 840 etc., as shown in FIG. 8A. It is contemplated that any information in the user profile 220 may be included in the profile message 800, including consumer defined preferences 405, device information 410, desirable subject matter 430, desirable ad types 440, page layout preferences 450, rate settings 460.

As an example, validated demographic information 810 may be pulled from the data privacy manager 178 in accordance with the consumer-defined preference 405 and included in the profile message 500. For each entry in the demographic information 420, a reliability confidence level 812 may be provided. The reliability confidence level 812 may be encoded on a scale, for example, on a one-to-five scale where one represents low confidence (less than twenty percent) and five represents very high confidence (greater than eighty percent). For example, the validated demographic information 810 may include the consumer's age and an associated reliability confidence level of “four” indicating a high, but not the highest level of confidence. The reliability confidence level 812 may be calculated by the system 100 by comparing the consumer provided information to external databases and to expected user behavior (content consumption, purchasing behavior, etc.) for the consumer's stated demographic.

In an embodiment, the profile message 800 may include listings of impending purchase information 820 of the consumer 120. For each impending purchase, impending purchase information 820 may define a category 821 in which the consumer 120 has expressed an interest in purchasing goods or services. The expression of interest may be explicit, as shown in FIG. 4B, by the system 100 querying the consumer 120 about impending purchases or may be implicit, for example, the system 100 may infer purchase intent from the consumer's behavior, such as, based on the consumer's web browsing behavior, content consumption, etc., or as inferred from any other data collected on the consumer 120 by the system 100. Depending on the information available to the system 100 and the consumer defined preferences, the impending purchase information 820 may be more specific than just identifying a category 821, but may include an actual identification of the goods or services, e.g., a car, or a mortgage. Indeed, it is contemplated that the identification may include a specific branded product that the consumer is considering purchasing, e.g., an “American Motors Rambler” or a “First Chicago Bank home mortgage for $300,000.”

Additionally, for each impending purchase, the impending purchase information 820 may include an expected amount 822 for the impending purchase. The expected amount 822 may be encoded based on amount encoding 852 as shown in FIG. 8B, for example, the amount may be fifty to one hundred dollars, one thousand dollars to five thousand dollars, ten thousand to fifteen thousand dollars, etc. Further, for each impending purchase, the impending purchase information 820 may include timing information 823 that may define an expected time of purchase for the impending purchase. The timing information 823 may be encoded by timing encoding 853 as shown in FIG. 8B. For example, the expected time of purchase may be less than one hour, today, two to three days, etc.

In an embodiment, the profile message 800 may include minimum rates 826 for advertisers 162 to display advertising of a particular ad type 825 on a particular device 824. For example, the minimum rate 826 may be five cents for a banner ad displayed on the consumer's iPhone. In an embodiment, the minimum rates 826, the ad type 825, and the device 824 may be encoded using minimum hosting ad rates 856, ad type encoding 855, and device type encoding 854, respectively, as shown in FIG. 8B.

In an embodiment, the profile message 800 may include user behavior scores 830 for various measures of consumer behavior. For example, user behavior scores may include click through frequency scores 831. As shown in FIG. 8A, the click through frequency scores 831 may be provided on a per category basis, that is, for each category 833, the consumer 120 may be assigned a level 834 on a one-to-five scale (as described with reference to the profile reliability confidence level 812. Additional user behavior scores may include an online purchase frequency score 832, user purchase demographics, average time between searching a product and purchase, a number of review clicks (or visits) on a review website prior to purchase, etc.

In an embodiment, the profile message 800 may include ad content preferences 840. The ad content preferences 840 may be expressed as categories and brands that the consumer 120 would like to receive advertising for (like categories 841 and like brands 842), and categories and brands that the user would not like to receive advertising for (dislike categories 843 and dislike brands 844). As shown, the categories in the ad content preferences 840 may be encoded using category encoding 851 as shown in FIG. 8B. Likewise, brands in the ad content preferences may be encoded using brand encoding 857 as shown in FIG. 8B. In other embodiments, instead of like brands 842 and dislike brands 844, the ad content preferences may be expressed based on products, for example, liked products and disliked products. In this way, a consumer 120 may express a preference for receiving ads for coffee and express a preference to not receive ads for baby strollers.

As described with reference to FIG. 1, the consumer-controlled advertising system 100 may include may include various logical elements, such as, a content proxy 172, an advertisement content gateway 174, an advertising auction or coordinator 175, a data privacy manager 178, a user data storage 180, a grouped data storage 182, a validation engine 184, a data grouping engine 186, an advertiser access gateway 188, an advertising management system 190, and a management interface 192. In an embodiment, the elements of the consumer controlled advertising system 100 may be embodied in conventional hardware and software computer systems.

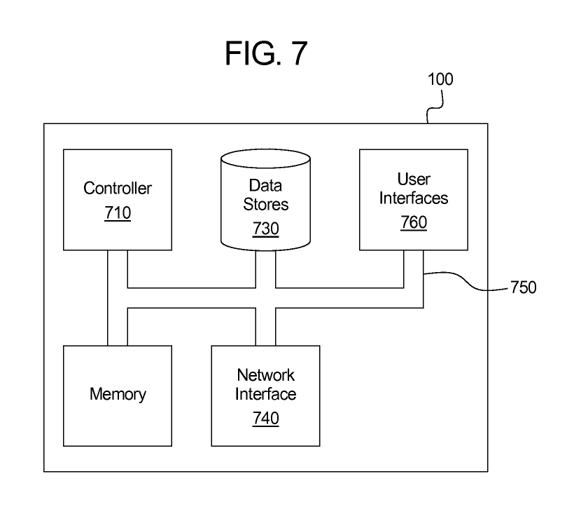

For example, as shown in FIG. 7, the consumer-controlled advertising system 100 may include one or more controller(s) 710 that execute instructions stored in a memory 720 to provide the functionality of the various logical elements. The controller 710 may be in communication with various data stores 730 that provide the storage for elements such as the user data storage 180, the grouped data storage 182, etc. Additionally, the controller 710 additionally may be in communication with a network interface 740 to communicate with user devices 122 and advertisers 162. Moreover, the controller 710 may communicate with the memory 720, the data stores 730, the network interface 740, etc., via a communications bus 750. Further, the controller 710 may be in communication with one or more user interfaces 760.

The one or more controllers 710 may be adapted run a variety of application programs, access and store data, including accessing and storing data in associated databases, and enable one or more interactions via the consumer-controlled advertising system 100. Typically, the one or more controllers 710 are implemented by one or more programmable data processing devices. The hardware elements, operating systems, and programming languages of such devices are conventional in nature, and it is presumed that those skilled in the art are adequately familiar therewith.

For example, the one or more controllers 710 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories 720 include a main memory, such as a dynamic random access memory (DRAM) and cache, as well as a read only memory, such as a PROM, EPROM, FLASH-EPROM, or the like. The system may also include any form of volatile or non-volatile memory 720. In operation, the main memory 102 stores at least portions of instructions for execution by the CPU and data for processing in accord with the executed instructions.

The one or more controllers 710 may also include one or more input/output interfaces for communications with one or more processing systems. One or more such interfaces may include a network interface 740 to enable communications via a network, e.g., to enable sending and receiving instructions electronically. The communication links may be wired or wireless.

The one or more controllers 710 may further include appropriate input/output ports for interconnection with one or more output displays (e.g., monitors, printers, touchscreen, motion-sensing input device, etc.) and one or more input mechanisms (e.g., keyboard, mouse, voice, touch, bioelectric devices, magnetic reader, RFID reader, barcode reader, touchscreen, motion-sensing input device, etc.) serving as one or more user interfaces 760 for the processor. For example, the one or more controllers 101 may include a graphics subsystem to drive the output display. The links of the peripherals to the system may be wired connections or use wireless communications.

Although summarized above as a PC-type implementation, those skilled in the art will recognize that the one or more controllers 710 also encompasses systems such as host computers, servers, workstations, network terminals, and the like. Further one or more controllers 710 may be embodied in a device, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller 710 or other programmable equipment to perform the relevant steps, where the code or instructions are carried by or otherwise embodied in a non-transitory medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a controller 710 for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A user-controlled advertising system comprising:
a network interface in communication with a user device and one or more advertiser systems;
user data storage including a user profile associated with the user device;
a controller in communication with the network interface and the user data storage;
memory in communication with the controller, the memory including instructions, that when executed by the controller, cause the controller to:
receive a request from the user device identifying content from a content provider;
retrieve the content from the content provider;
identify first advertising in the content;
send an advertising request to the one or more advertiser systems, the advertising request identifying demographic information from the user profile;
receive, from the one or more advertiser systems, a set of prospective advertisements, wherein each prospective advertisement is associated with a rate;
select an advertisement from the set of prospective advertisements associated with a highest rate;
when the selected advertisement exceeds a reserve rate defined by the user profile;
replace the first advertising with the selected advertising; and
provide the content to the user device.

2. The user-controlled advertising system of claim 1, further including the instructions that cause the controller to:
when the selected advertisement exceeds the reserve rate defined by the user profile, debit an account of an advertiser providing the selected advertisement in an amount of the reserve rate and credit the account of the user profile in the amount of the reserve rate.

3. The user-controlled advertising system of claim 1, wherein the advertising request includes reliability scores, wherein each reliability score is associated with an entry in the demographic information.

4. The user-controlled advertising system of claim 1, wherein the demographic information includes an age, gender, zip code, and a FICO score.

5. The user-controlled advertising system of claim 1, wherein the advertising request includes impending purchase information, wherein the impending purchase information indicates a category of a purchase, an expected purchase amount, and a expected purchase timeline.

6. The user-controlled advertising system of claim 1, wherein the advertising request includes ad content preferences including an ad content type.

7. The user-controlled advertising system of claim 1, wherein the advertising request includes a user behavior score, wherein the controller derives a user behavior score from an accessed content history of user devices associated with the user profile, wherein the user behavior score includes a value for an observed behavior in a category of goods and services.

8. The user-controlled advertising system of claim 7, wherein the observed behavior is a click through frequency for advertising provided by the user-controlled advertising system in the category of goods and services.

9. The user-controlled advertising system of claim 7, wherein the observed behavior is an online purchase frequency of goods and services in the category of goods and services.

10. The user-controlled advertising system of claim 1, wherein the controller further identifies dimensions of the first advertising, wherein the advertising request includes a request for advertising of the dimensions, wherein, upon receiving the set of prospective advertisements and before selecting the advertisement from the set of prospective advertisements associated with the highest rate, the controller removes from the set the prospective advertisements any prospective advertisements that fail to meet the dimensions.

11. The user-controlled advertising system of claim 1, wherein, upon receiving the set of prospective advertisements and before selecting the advertisement from the set of prospective advertisements associated with the highest rate, the controller removes from the set the prospective advertisements any prospective advertisements that fail to meet consumer defined preferences, wherein the consumer-defined preferences include desirable subject matter preferences and desirable ad type preferences.

12. A user-controlled advertising system comprising:
an advertisement content gateway in communication with one or more advertiser systems;
user data storage in communication with the advertisement content gateway, wherein the user data storage includes a user profile associated with the user device;
a user device in communication with the advertisement content gateway and a content provider, wherein the user device receives content including first advertising from the content provider, wherein, in response to receiving the content, the user device makes a request to the advertisement content gateway, wherein, upon receiving a response from the advertisement content gateway including second advertising, the user device replaces the first advertising in the content with the second advertising and displays the content on a user interface of the user device;
wherein, in response to receiving the request from the user device, the advertisement content gateway:
sends an advertising request to the one or more advertiser systems, the advertising request identifying demographic information from the user profile,
receives, from the one or more advertiser systems, a set of prospective advertisements, wherein each prospective advertisement is associated with a rate,
selects an advertisement from the set of prospective advertisements associated with a highest rate,
when the selected advertisement exceeds a reserve rate defined by the user profile, sends the selected advertisement to the user device as the second advertising.

13. The user-controlled advertising system of claim 12, further including a management interface that when the selected advertisement exceeds the reserve rate, debits an account of an advertiser providing the selected advertisement in an amount of the reserve rate and credits the account of the user profile in the amount of the reserve rate.

14. The user-controlled advertising system of claim 12, wherein the advertising request includes reliability scores, wherein each reliability score is associated with an entry in the demographic information.

15. The user-controlled advertising system of claim 12, wherein the demographic information includes an age, gender, zip code, and a FICO score.

16. The user-controlled advertising system of claim 12, wherein the advertising request includes impending purchase information, wherein the impending purchase information indicates a category of a purchase, an expected purchase amount, and a expected purchase timeline.

17. The user-controlled advertising system of claim 12, wherein the advertising request includes ad content preferences including an ad content type.

18. The user-controlled advertising system of claim 12, wherein the advertising request includes a user behavior score, wherein the controller derives a user behavior score from an accessed content history of user devices associated with the user profile, wherein the user behavior score includes a value for an observed behavior in a category of goods and services.

19. The user-controlled advertising system of claim 18, wherein the observed behavior is a click through frequency for advertising provided by the user-controlled advertising system in the category of goods and services.

20. A user-controlled advertising system comprising:
an advertisement content gateway;
a management interface;
a network interface in communication with the advertisement content gateway;
a user interface;
a controller in communication with the advertisement content gateway, the management interface, the network interface, and the user interface;
memory in communication with the controller, the memory including instructions, that when executed by the controller, cause the controller to:
receive content including first advertising in an advertising area of the content;
receive a preference question from the management interface;
replace the first advertising with the preference question within the advertising area of the content;
display the content on the user interface;
receive a preference from the user interface;
receive second content including second advertising;
send an advertising request to the advertisement content gateway,
receive third advertising from the advertisement content gateway, wherein the advertisement content gateway selects the third advertising using the preference;
replace the second advertising in the second content with the third advertising; and
display the second content on the user interface.
